(19) United States
(12) Patent Application Publication
(10) Pub. No.: US 2013/0207991 A1
(43) Pub. Date: Aug. 15, 2013

(54) WEARABLE DISPLAYS METHODS, AND COMPUTER-READABLE MEDIA FOR DETERMINING DISPLAY CONDITIONS

(71) Applicants: Tomohiro SATO, Nagoya-shi (JP); Miwa NAKANISHI, Yokohama-shi (JP)

(72) Inventors: Tomohiro SATO, Nagoya-shi (JP); Miwa NAKANISHI, Yokohama-shi (JP)

(73) Assignee: BROTHER KOGYO KABUSHIKI KAISHA, Nagoya-shi (JP)

(21) Appl. No.: 13/848,028

(22) Filed: Mar. 20, 2013

Related U.S. Application Data
(63) Continuation-in-part of application No. PCT/JP2011/077914, filed on Dec. 2, 2011.

(30) Foreign Application Priority Data
Dec. 3, 2010 (JP) 2010-269918

(51) Int. Cl. G02B 27/01

(52) U.S. Cl. CPC G02B 27/017
USPC 345/589

(57) ABSTRACT

A wearable display includes processors and a memory. The memory stores computer-readable instructions therein. When executed by the processors, the instructions instruct the processors to perform certain processes. The instructions instruct the processors to obtain a color level of an environment external to the wearable display. The instructions instruct the processors to determine a quantity of display colors based on the color level. The instructions instruct the processors to control a display device to display an image using a number of display colors equal to the quantity of display colors determined based on the color level. The image includes display objects. Each of the display objects is displayed in at least one of the display colors.

### CROSS-REFERENCE TO RELATED APPLICATIONS

The present application is a continuation-in-part of International Application No. PCT/JP2011/077914, filed on Dec. 2, 2011, which claims the benefit of Japanese Patent Application No. 2010-269918, filed on Dec. 3, 2010, the disclosures of which are incorporated herein by reference.

### BACKGROUND OF THE DISCLOSURE

1. Field of the Disclosure

The disclosure relates generally to image display systems and more specifically to wearable displays, methods, and computer-readable media for determining display conditions.

2. Description of the Related Art

A known head-mountable display (“HMD”) projects image light, which represents an image, toward an eye of a user. The known HMD enables the user to directly observe an image without a screen on which the image would otherwise be displayed.

A known see-through HMD enables the user to observe an image overlapped on an external scene. The see-through HMD displays a reference screen that allows the user to perform work while observing the external scene.

Known see-through HMDs are classified into spatial modulation type HMDs and scanning type HMDs. A spatial modulation type HMD comprises an image light forming device comprising liquid crystal elements, which operate according to image signals, light sources, or organic electroluminescence (“EL”) elements. A scanning type HMD comprises an image light forming device, which comprises light sources that emit light of various intensities based on image signals, and a light scanning device, which creates an image light by scanning incident light from the light sources.

### SUMMARY OF THE DISCLOSURE

After various studies of see-through HMDs, the inventors have recognized that comfort (e.g., ease of viewing) of a user associated with viewing a displayed image (e.g., image light projected toward a user) overlapped on an external scene (e.g., the “real world,” environmental objects in the user's line of sight) may change depending on the type of external scene. Maintaining a consistent level of comfort when displaying an image with a see-through HMD, regardless the type of external scene, may be desirable to a user of the see-through HMD. In view of this recognition by the inventors, the present disclosure discloses a see-through HMD that may maintain the level of comfort of a user associated with images displayed on a see-through HMD, even when an external scene in the user's line of sight changes.

A wearable display disclosed herein may include a camera, a color level obtaining device, a color determining device, and a display device. The camera may be configured to record an image of an environment external to the wearable display. The color level obtaining device may be configured to obtain a color level from the image of the environment external to the wearable display. The color determining device may be configured to determine a quantity of display colors based on the color level. The display device may be configured to display an image using a number of display colors equal to the quantity of display colors determined based on the color level. The image may include one or more display objects. Each display object of the one or more display objects may be displayed in at least one of the display colors.

Another wearable display disclosed herein may include one or more processors and a memory. The memory may be configured to store computer-readable instructions therein. When executed by the one or more processors, the computer-readable instructions may instruct the one or more processors to perform certain processes. The instructions may instruct the one or more processors to obtain a color level of an environment external to the wearable display. The instructions may instruct the one or more processors to determine a quantity of display colors based on the color level. The instructions may instruct the one or more processors to control a display device to display an image using a number of display colors equal to the quantity of display colors determined based on the color level. The image may include one or more display objects. Each display object of the one or more display objects may be displayed in at least one of the display colors.

Computer readable media disclosed herein may store computer-readable instructions therein. The computer-readable instructions may instruct one or more processors of a wearable display to perform certain processes when executed by the one or more processors. The instructions may instruct the one or more processors to obtain a color level of an environment external to the wearable display. The instructions may instruct the one or more processors to determine a quantity of display colors based on the color level. The instructions may instruct the one or more processors to control a display device to display an image using a number of display colors equal to the quantity of display colors determined based on the color level. The image may include one or more display objects. Each display object of the one or more display objects may be displayed in at least one of the display colors.

A method disclosed herein may include performing certain processes using one or more processors of a wearable display. The method may include obtaining a color level of an environment external to the wearable display. The method may include determining a quantity of display colors based on the color level. The method may include controlling a display device to display an image using a number of display colors equal to the quantity of display colors determined based on the color level. The image may include one or more display objects. Each display object of the one or more display objects may be displayed in at least one of the display colors.

Other objects, features, and advantages will be apparent to persons of ordinary skill in the art from the following detailed description of the disclosure and the accompanying drawings.

### BRIEF DESCRIPTION OF THE DRAWINGS

For a more complete understanding of the present disclosure, needs satisfied thereby, and the objects, features, and advantages thereof, reference now is made to the following descriptions taken in connection with the accompanying drawings.

FIG. 1 is a plan view showing a see-through HMD.

FIG. 2 is a schematic diagram showing a schematic representation of an internal structure of the HMD shown in FIG. 1.

FIG. 3 is a schematic diagram showing the control device indicated in FIG. 2.

FIG. 4 shows one example of information items that were used in an experiment by the inventors to determine how to enhance the experience of using the HMD shown in FIG. 1.

FIG. 5 shows five types of patterns that were used during the experiment to simulate a “real world” environment external to the HMD shown in FIG. 1.

FIG. 6A is graph showing a result of an experiment that represents a relationship between font sizes of the information items and comfort levels that test subjects felt during the observation of the information items.

FIG. 6B is a chart showing another result of an experiment that represents a relationship between positions in which the information items were displayed in an image display area of the HMD and comfort levels that the test subjects felt during the observation of the information items.

FIG. 7A is a graph showing a result of an experiment that represents a relationship between the types of patterns, background colors, and comfort levels that the test subjects felt during the observation of the information items.

FIG. 7B is a graph showing a result of an experiment that represents a relationship between the percentage of test subjects correctly identifying the information items, the type of pattern, and the number and placement of information items.

FIG. 7C is a graph showing a result of an experiment that represents a relationship between the types of patterns, the number of colors used in color-coding schemes of information items, and comfort levels that the test subject felt during the observation of the information items.

FIG. 8 is a flowchart that shows a quantity of colors determining process.

FIG. 9A is a schematic diagram showing an example of a divided display obtained in steps S112 and S113 shown in FIG. 8.

FIG. 9B is a schematic diagram showing an example of a divided display obtained in steps S125 and S126 shown in FIG. 8.

FIG. 10 is a flowchart that shows an external environment response process.

### DETAILED DESCRIPTION OF EMBODIMENTS OF THE INVENTION

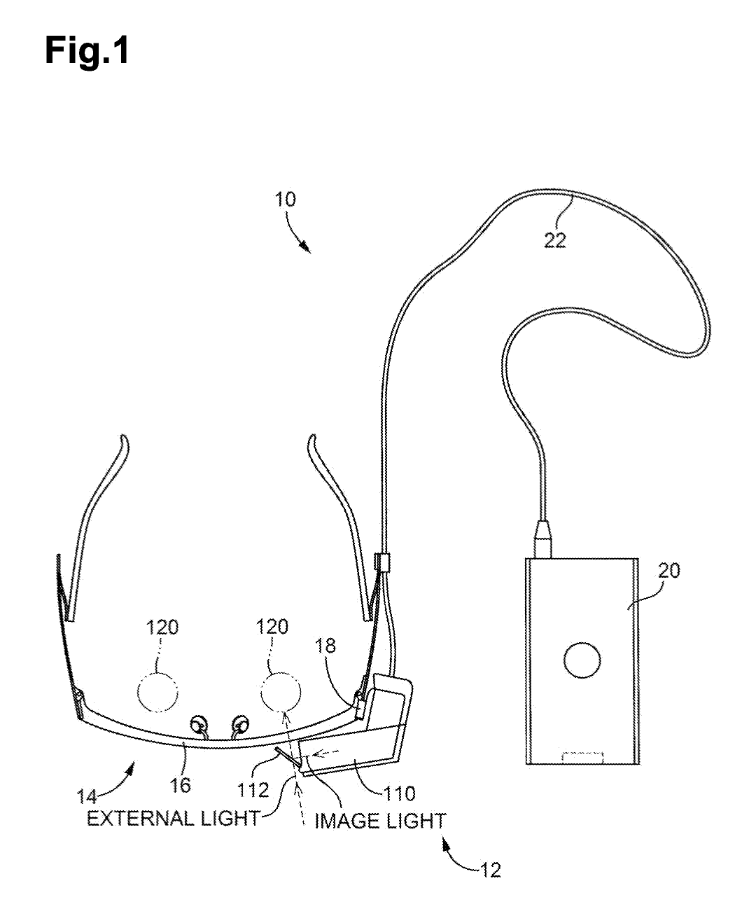

Wearable displays, such as, for example, the HMD 10 depicted in FIG. 1 may comprise a projection device 12, which may be configured to project image light representing an image toward a light receiver, such as, for example, an eye of a user. The projection device 12 may be configured to mount on an object, such as, for example, the head of the user, with a frame 16.

For example, the frame 16 may be configured to attach to the head of the user by being placed on the ears of the user. The projection device 12 may be attached to part of the frame 16 through an attachment device 18, for example.

The projection device 12 and a control device 20 (e.g., a controller), which may control the projection device 12, now is disclosed with reference to FIGS. 1-3.

FIG. 1 shows a plan view of the projection device 12. The projection device 12 may project image light toward a light receiver, such as, for example, an eye of a user, to display an image (e.g., to display an image for the user). The projection device 12 may be of a retina scanning type. The projection device 12 may project light emitted from a light source toward a light receiver, such as, for example, a retina, and also may scan the projected light on the light receiver. When the light receiver is an eye of a user or, more specifically, a retina of a user, the projecting and scanning by the projection device 12 may enable the user to observe the image as a virtual image. The projection device 12 may be a see-through type projection device, which may enable the light receiver (e.g., a user, an eye of a user, a retina of a user, an optical element) to observe a displayed image overlapped with an external scene. In some configurations, the projection device 12 may be provided for a plurality of light receivers, such as, for example, both eyes of the user. In certain configurations, the projection device 12 may be configured to spatially modulate light emitted from a surface light source for each pixel by using spatial modulating elements, such as those used in a liquid crystal display (“LCD”), and may project the modulated light onto the light receiver. The projection device 20 may be an example of a display device. Such display devices may comprise, for example, various projectors, LCDs, and EL displays.

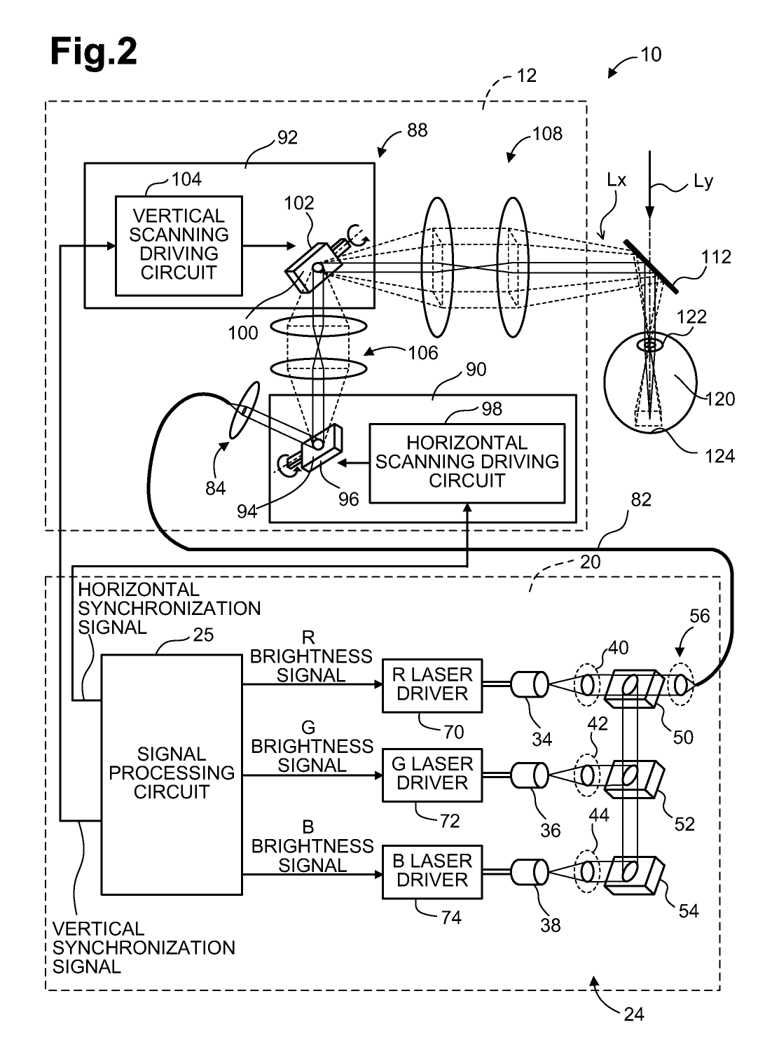

The control device 20 now is described. For example, the control device 20 may be connected to the projection device 12 through a cable 22 as shown in FIGS. 1 and 2. The cable 22 may comprise a control line, which may supply control signals; a power line, which may supply electric power; and an optical fiber 82 (described below), which may transmit light. Although the projection device 12 may be configured to be mounted on an object, such as the head of the user, the control device 20 may be mounted elsewhere or on another object (e.g., worn on a region of the user other than the head, such as, for example, the user's waist).

As shown in FIG. 2, the control device 20 may comprise a light source device 24 that may emit light, such as, for example, linear image light (e.g., RGB color laser beams). The structure of the light source device 24 is described below in detail. The control device 20 may comprise a signal processing circuit 25 that may comprise a computer (e.g., a processor, a controller) as the main component.

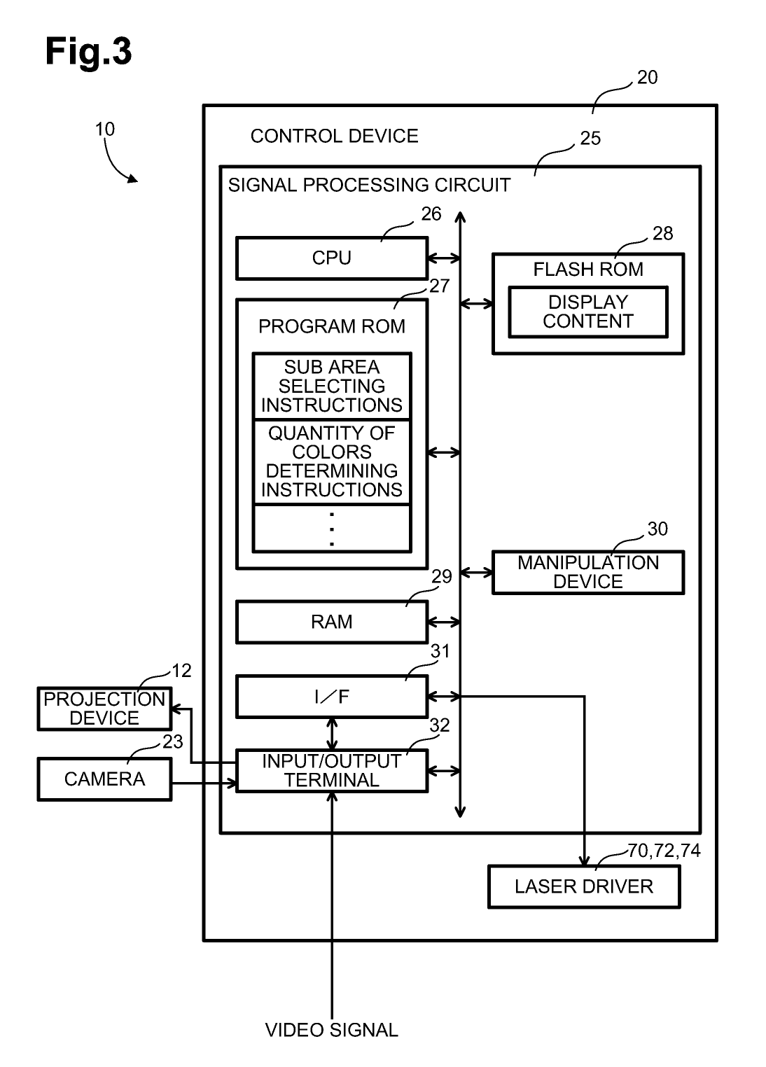

As conceptually shown in FIG. 3, the signal processing circuit 25 may comprise one or more of a central processing unit (“CPU”) 26, which may function as a processor; a program read-only memory (“ROM”) 27; a flash ROM 28; a random-access memory (“RAM”) 29, which may be a volatile memory; a manipulation device 30 (e.g., keys, buttons, a touch panel); an input/output interface (“I/F”) 31; external input/output terminals 32; and a bus 33 that may mutually connect these constituent elements.

An external device (not shown), such as, for example, a personal computer, a tablet, or a mobile phone, may connect to the external input/output terminals 32. Video signals may enter from the external device through the external input/output terminals 32 to the signal processing circuit 25. The video signals may represent display content to be displayed by the projection device 12. The display content may be, for example, one or more of a still image, a moving image, and other possible forms of displayable content. The display content may be stored in the flash ROM 28, for example.

The external input/output terminals 32 may connect to the projection device 12. In some configurations, a camera 23, such as, for example, a charge-coupled device (“CCD”) camera, may be mounted on the a surface (e.g., an upper surface, a lower surface, another surface) of the frame 16 with the HMD 10, as shown in FIG. 1. The camera 23 may image the environment external to the HMD 10 (e.g., an external environment, the “real world,” external scenes), which may, for example, be observed by the user together with the image light projected toward the user by the HMD 10. The camera 23 may connect to the external input/output terminals 32, and signals that represent image data obtained by the camera 23 may be input to the signal processing circuit 25.

The signal processing circuit 25 may create an R brightness signal, a G brightness signal, and a B brightness signal from the input video signal. The R brightness signal, the G brightness signal, and the B brightness signal may be used to modulate the intensity of image light for each component light (e.g., R, G, and B). The R brightness signal may represent the brightness of a red (“R”) laser beam (e.g., component image light). The G brightness signal may represent the brightness of a green (“G”) laser beam (e.g., component image light). The B brightness signal may represent the brightness of a blue (“B”) laser beam (e.g., component image light). In some configurations, the signal processing circuit 25 may create a horizontal synchronization signal and a vertical synchronization signal, which may be used as references in horizontal scanning and vertical scanning (described below).

The light source device 24 now is disclosed in detail with reference to FIG. 2. The light source device 24 may comprise three lasers (e.g., lasers 34, 36, and 38), three collimator lenses (e.g., collimator lenses 40, 42 and 44), three dichroic mirrors (e.g., dichroic mirrors 50, 52 and 54), and a combined optical system 56.

The three lasers may comprise, for example, the R laser 34 that may generate red laser beams, the G laser 36 that may generate green laser beams, and the B laser 38 that may generate blue laser beams. The lasers 34, 36, and 38 may be, for example, one or more of semiconductor lasers or solid lasers.

The collimator lenses 40, 42, and 44 may collimate three-color laser beams emitted from the three lasers 34, 36, and 38, which may collimate a total of three colors. The dichroic mirrors 50, 52, and 54 may selectively perform reflection and transmission of the relevant laser beams based on the wavelength thereof, such that the three color laser beams directed from the three collimator lenses may be mutually combined.

The three color laser beams may be mutually combined by a single representative dichroic mirror that may typify the dichroic mirrors 50, 52, and 54. In particular configurations, the dichroic mirror 50 may be selected as the representative dichroic mirror. The laser beams combined by the dichroic mirror 50 may be incident on the combined optical system 56 as combined laser beams (e.g., combined image light) and focused.

As shown in FIG. 2, the lasers 34, 36, and 38 may be electrically connected to the signal processing circuit 25 through laser drivers 70, 72, and 74, respectively. The signal processing circuit 25 may modulate the intensities of the laser beams emitted from the lasers 34, 36, and 38 through the corresponding laser drivers 70, 72, and 74, according to the R brightness signal, the G brightness signal, and the B brightness signal.

As shown in FIG. 2, the laser beams directed from the combined optical system 56, which is combined image light (referred to below as “laser beams”), may be transmitted to a collimator lens 84 in the projection device 12 through the optical fiber 82, which may be used as an optical transmission medium. The laser beams subsequently may be collimated by the collimator lens 84 and may be output, after which the laser beams may enter a scanning device 88 in the projection device 12.

The projection device 12 now is disclosed with reference to FIG. 2. The projection device 12 may comprise the scanning device 88. The scanning device 88 may comprise one or more of a horizontal scanning device 90 and a vertical scanning device 92.

The horizontal scanning device 90 may comprise one or more of a resonance-type deflector 96 and a horizontal scanning driving circuit 98. The resonance-type deflector 96 may comprise a deflection surface 94 (e.g., a reflection surface) that may deflect incident laser beams and may be swung bi-directionally to horizontally scan the deflected light. The horizontal scanning driving circuit 98 may drive the resonance-type deflector 96 according to the horizontal synchronization signal supplied from the signal processing circuit 25.

Similarly, the vertical scanning device 92 may comprise one or more of a non-resonance-type deflector 102 and a vertical scanning driving circuit 104. The non-resonance-type deflector 102 may comprise a deflection surface 100 (e.g., a reflection surface) that may deflect incident laser beams and may be swung bi-directionally to vertically scan the deflected light. The vertical scanning driving circuit 104 may drive the non-resonance-type deflector 102 by using a driving signal with, for example, a sawtooth waveform based on the vertical synchronization signal supplied from the signal processing circuit 25.

As shown in FIG. 2, the laser beams output from the horizontal scanning device 90 may enter a first relay optical system 106, by which the laser beams may be converged, after which the converged laser beams may enter the vertical scanning device 92.

The laser beams scanned by the scanning device 88 may enter a second relay optical system 108, by which the laser beams may be converged, after which the converged laser beams may exit from an exit opening formed in the projection device 12. As shown in FIG. 1, a half mirror 112 may be attached to a housing 110 in the projection device 12.

The laser beams that have exited from the projection device 12 may enter the half mirror 112, as shown in FIGS. 1 and 2. The incident laser beams may reflect on the half mirror 112, exiting the projection device 12, and may, for example, pass through the pupil 122 in an eyeball 120 of the user and focus on a retina 124 in the eyeball 120 of the user.

The laser beams, which may be incident on the retina 124, may be scanned on the retina 124, and the scanned laser beams may be converted to sheet-light image light. Accordingly, the user may observe a two-dimensional image as a virtual image in one eye. In particular configurations, light from the environment external to the HMD 10 (e.g., light from the “real world,” light from an external scene) may be transmitted through the half mirror 112 and may enter the one eye with the image light that has reflected on the half mirror 112. As a result, the user may observe an external scene together with the image displayed by the image light.

The HMD 10 may display an image (e.g., a moving image, a still image) in a display area (e.g., a rectangular display area, a display area of another shape) according to externally entered video signals. The displayed image may comprise at least one display object. An example of a display object may be an information item that may be formed with a plurality of characters (e.g., digits, symbols, icons), each of which may have a unique meaning Each display object may be formed with an image.

Unlike a moving image or a still image intended for appreciation, the information item may not comprise a unique attribute (e.g., a thickness, a color, a position of a line to be displayed). In certain configurations, the attribute of the information item may be freely edited and changed. The information item may be, for example, text data. Consequently, even when the attribute of the information item (e.g., the text) is changed, as long as the contents of the information item remains unchanged, the amount of information conveyed by the information item may not deteriorate.

When an attribute of an information item (e.g., a display condition) is enhanced by the HMD 10, such enhancement may increase the ease with which the user may view the information item generated by HMD 10 (e.g., the visibility of the information item. Nevertheless, the degree of the visibility of an information item may not be determined by the attribute of the information item alone. In particular configurations in which the HMD 10 is of see-through type, the HMD 10 may enable the user to view an information item overlapping an external scene; however, the degree of the visibility of the displayed information item may be changed by attributes of an image in the external scene (e.g., attributes of the environment external to the HMD 10).

To optimize the attribute of the information item in the background of this situation, The inventors carried out an experiment by using a prototype of the HMD 10 to determine ways to enhance the attributes of the information item in the background of an external scene, and the inventors designed configurations of the HMD 10 on the basis of the results of the experiment. The experiment that the inventors carried out, the experimental results, and considerations related to the experimental results are described below in detail.

The experiment was carried out by the inventors to obtain display conditions (e.g., one or more of colors and positions of information items) that may enable a user of HMD 10 to appropriately view the information items when the user observes the information items overlapped with an external scene. The information items may be handled as objects displayed by the HMD shown in FIG. 1. In the experiment carried out by the inventors, a scene was simulated in which a worker, while observing a work piece in an external scene, referenced work-aiding information (e.g., an information item) in the image display area of the HMD 10 that may be important.

A monitor having a 42-inch screen was used to simulate an external scene. Five variations of display patterns were used.

Observation was carried out at a position 75 cm distant from the monitor so that a plurality of test subjects could sit for the test sequentially.

The HMD 10 was mounted on the head of each test subject such that the projection device 12 faced to a non-dominant eye of each test subject. The non-dominant eye was determined to be the eye opposite to the dominant eye. The left eye was the non-dominant eye for all test subjects in this experiment. Information items were displayed from the image display area of the HMD 10 in a display form in which the information items were changed sequentially.

The test subject transcribed information displayed on the HMD 10 for each task and entered, using a keyboard, a subjective evaluation result that represented whether the display condition was comfortable (described below). The information displayed on the HMD 10 was used to calculate a correct answer ratio that represented a degree to which the test subject correctly recognized the information item. The subjective evaluation result was used to calculate a ratio (in percent) indicating the comfort level of the group of test subjects. In particular, the ratio was determined as a ratio of the number of test subjects that subjectively evaluated the display condition as a comfortable display condition to all test subjects.

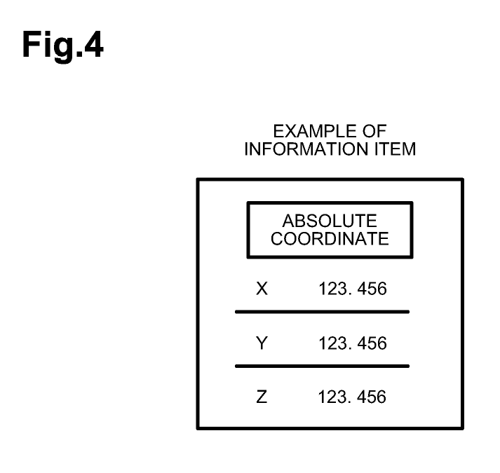

As shown in FIG. 4, the information item used in this experiment comprised a plurality of characters, digits, symbols, underlines, and closing lines.

Each font size of a plurality of font sizes (e.g., 18 points, 26 points, 34 points, 42 points, and 50 points) was used to display the information item.

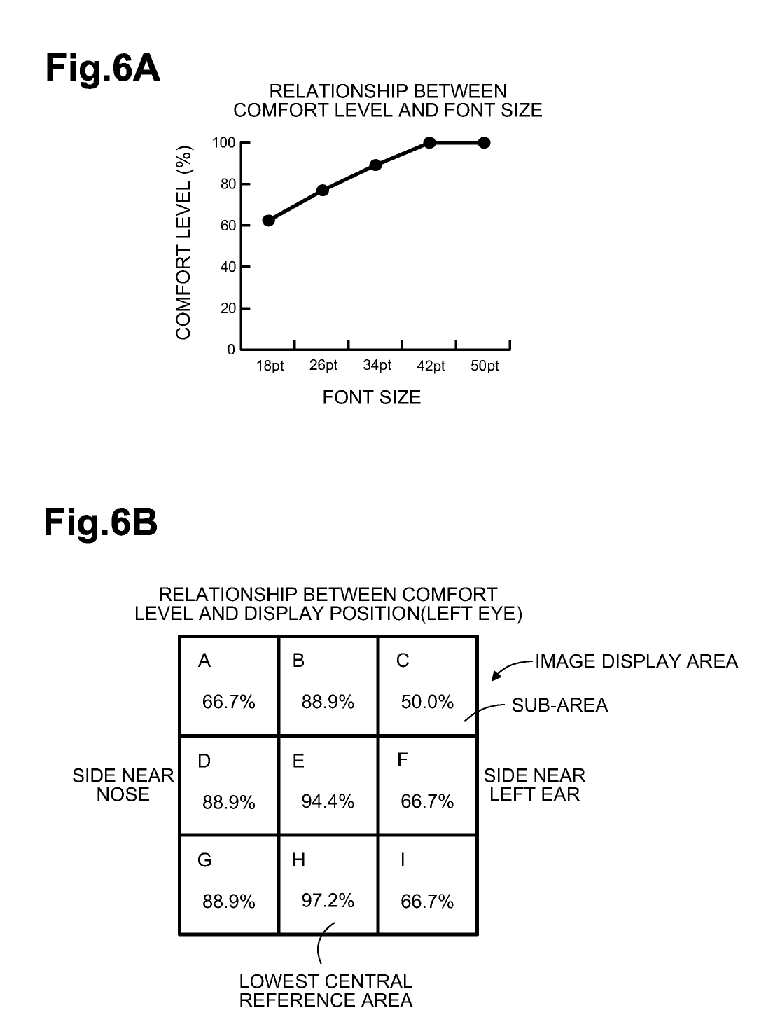

The information item was displayed in nine sub-areas (e.g., sub-areas, reference areas) of the image display area of the HMD 10. The nine sub-areas were obtained by equally dividing the image display area into three vertical areas and three horizontal areas (e.g., as shown in FIG. 6B). These nine sub-areas formed a matrix of three rows and three columns. The position of each sub-area was represented as (i, j), in which i was an integer (e.g., 1, 2, or 3) representing a row number incremented from the top toward the bottom, and in which j was an integer (e.g., 1, 2, or 3) representing a column number incremented from the side near the nose of the test subject toward the ear nearest the non-dominant eye of the test subject.

In FIG. 6B, the sub-area (1, 1) is denoted A, the sub-area (1, 2) is denoted B, the sub-area (1, 3) is denoted C, the sub-area (2, 1) is denoted D the sub-area (2, 2) is denoted E the sub-area (2, 3) is denoted F, the sub-area (3, 1) is denoted G, the sub-area (3, 2) is denoted H, and the sub-area (3, 3) is denoted I.

The background colors used for the information item were as follows:

BB: The entire background is in black (e.g., complete black);

WW: The entire background is in white (e.g., complete white); and

BW: Only the periphery of the information item is in white within the entire background

Fourteen colors were used to display the information item. The fourteen colors discretely covered all colors perceptible to humans.

A plurality of identical information items were displayed in varying numbers and display positions according to various display configurations, as described below. The following list identifies some of the various display configurations:

AL: Each of the nine information items are displayed at once in each of the nine sub-areas;

HL: Each of the three information items are displayed at once in each of the three sub-areas aligned in one row;

VL: Each of the three information items are displayed at once) in each of the three sub-areas aligned in one column; and

SG: The single information item is displayed in any one of the nine sub-areas.

The nine information items displayed in all the nine display positions (e.g., sub-areas) were displayed with the following color-coding:

A same color (e.g., a single color) is used to display each of the nine information items;

Different colors are used to display each of the nine information items; and

Different colors are used to display each group of three information items.

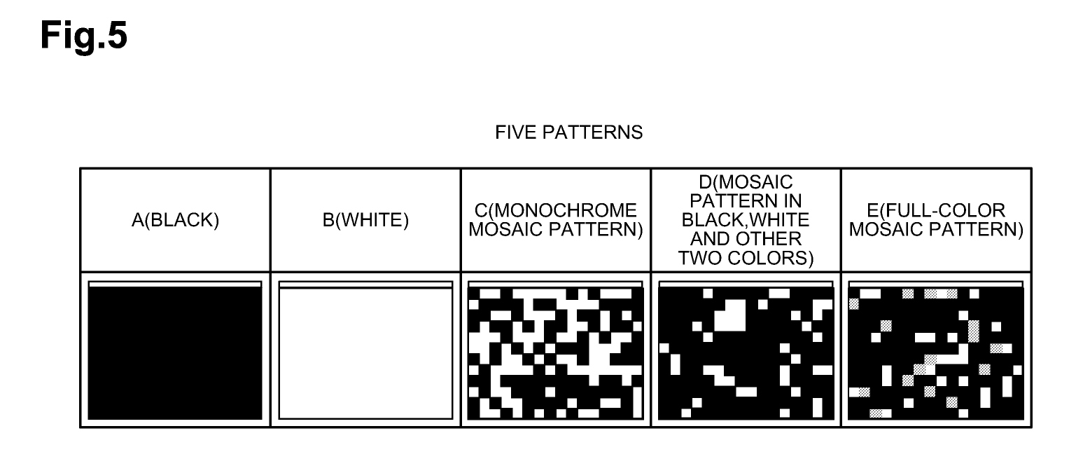

As shown in FIG. 5, an image displayed on the large monitor is displayed in any one of the following five patterns so as to reproduce a “real world” environment external to the HMD 10 with regard to the color level:

Pattern A: The entire image is in black;

Pattern B: The entire image is white;

Pattern C: Monochrome mosaic pattern in black and white;

Pattern D: Mosaic pattern in black, white, and two other colors; and

Pattern E: Full-color mosaic pattern.

The color level is an index that represents the number of mutually different colors in a field of view of the environment external to the HMD 10. The number of mutually different colors in a field of view is referred to below as the quantity of colors of the external environment. In particular, a low color level indicates a small quantity of colors in the external environment, and a high color level indicates a large quantity of colors of the external environment. It is also possible to interpret the color level as a term that indicates, for example, at least one of a color hue and the color level, as described above.

While simulating an external environment on the screen of the monitor, arbitrary letters were made to appear in random positions on the screen at random times. Each test subject pressed the “Enter” key of a keyboard when the test subject recognized that the arbitrary letters had appeared. Subsequently, an information item was displayed in the image display area of the HMD 10 in a display configuration selected from a plurality of display configurations that changed sequentially.

When the information item was displayed, each test subject used the keyboard to enter information about the content of the information items that the test subject was able to recognize. The accuracy of the test subject's recognition was measured according to the information entered using the keyboard.

Each time an information item was displayed, each test subject determined whether the display condition was comfortable (e.g., whether the information item was easy to view, whether the posture of the test subject in viewing the information item was not agonistic, and whether the movement of the eyeball of the test subject was appropriate) as part of a subjective evaluation provided by each test subject in regards to the display condition of the information item.

Each time each test subject completed one task, the test subject subjectively evaluated the comfort of the task using the visual analogue scale (“VAS”) method. The VAS method is an example of a technique to sensuously digitize the degree of the intensity of a stimulus that a human has received.

The experimental process comprised a plurality of steps. The first step comprised a process of determining a font size and display position that significantly enhanced the user experience. In the first step, each test subject executed the task described above for each of 135 configurations, which were combinations of the three background colors, five font sizes, and nine display positions. In the first step, other attributes (e.g., design elements) were arbitrarily determined and were left unchanged. The total number of test subjects was 12.

The second step comprised a process of determining a background color and display color that significantly enhanced the user experience. In the second step, each test subject executed the task described above for each of 210 configurations, which were combinations of the five patterns, three background colors, and 14 display colors. In the second step, the font size and display position that were evaluated as most-enhancing the user experience in the first step were used, and other attributes (e.g., design elements) were arbitrarily determined and were left unchanged. The total number of test subjects was 10.

The third step comprised a process of determining a quantity of items, positions of the items, and a quantity of colors in a color-coding scheme for the items that significantly enhanced the user experience. In the third step, each test subject executed the task described above for each of 60 configurations, which were combinations of the five patterns, the four combinations of the quantity of items and their positions (AL, SG, HL, and VL), and the three variations of the quantity of colors in each color-coding scheme. Each task was considered complete when the test subject entered content for the nine information items displayed in the nine sub-areas, respectively, using the keyboard. When the combination of the quantity of items and their positions was SG, HL, or VL, each test subject was required to perform a key operation to select an information item to be displayed. The total number of test subjects was 11.

When, for example, the combination of the quantity of items and their positions was HL, the information item shown in FIG. 4 was displayed in the three sub-areas A, B, and C, which were horizontally aligned in the topmost row, at the same time. When the test subject performed a key operation, the information item was displayed in the three sub-areas D, E, and F, which were horizontally aligned in the central row, at the same time. When the test subject further operated the key, the information item was displayed in the three sub-areas G, H, and I, which were horizontally aligned in the bottom row, at the same time.

In the third step, the font size and display position that were evaluated as most-enhancing the user experience in the first step were used, and the pattern, background color, and display color that were evaluated as most-enhancing the user experience in the second step were used.

FIG. 6A shows the percentage of test subjects that were comfortable viewing information items (e.g., the comfort level of the test subjects) as a function of font size that was determined during the experiment. The comfort level is provided as a percentage based on a ratio of configurations in which the test subjects subjectively evaluated that the display was comfortable to all configurations in the first step of the experiment. As shown in FIG. 6A, when the point size is 34 points or larger, the comfort level was 80% or more. Taking this result into consideration, the user experience may more likely be enhanced when the font size is set to be greater than or equal to 34 points.

FIG. 6B shows the comfort level of the test subjects for each information item of the information items displayed in each of the nine display positions in a configuration that used a font size of 34 points by geometrically associating the comfort level of the test subjects with the display position. Although not shown, the correct answer ratios of the test subjects were 60% or more regardless of the display position. Accordingly, it may be adequately concluded that all the display positions contribute positively to the user experience.

Nevertheless, the comfort levels shown in FIG. 6B, which are subjective evaluation values, may be used to determine relative differences among the nine display positions. The comfort levels determined in the experiment, based on a position of the information item, are listed in descending order (e.g., highest comfort level to lowest comfort level) below:

1. Sub-area H (bottom sub-area at the central column (3, 2)) (e.g., a lowest central reference area);

2. Sub-area E (central sub-area at the central column (2, 2));

3. Sub-areas D (central sub-area at the column closest to the nose (2, 1)), G (bottom sub-area at the column closest to the nose (3, 1)), and B (topmost sub-area at the central column (1, 2));

4. Sub-areas A (topmost sub-area at the column closest to the nose (1, 1)), F (central sub-area at the column closest to the left ear (2, 3)), and I (bottom sub-area at the column closest to the left ear (3, 3)); and

5. Sub-area C (topmost sub-area at the column closest to the left ear (1, 3)).

It may be important to display information items that have higher priorities in sub-areas having higher comfort levels so that a user may accurately recognize the contents of displayed information items having high priorities. Such an information item having a high priority may be, for example, an information item comprising content that may be important to the worker or frequently referenced by the worker. Accordingly, the order of the sub-areas in relation to the comfort levels may correspond to the order of the sub-areas in relation to the priority levels according to which the information items are displayed by the HMD 10.

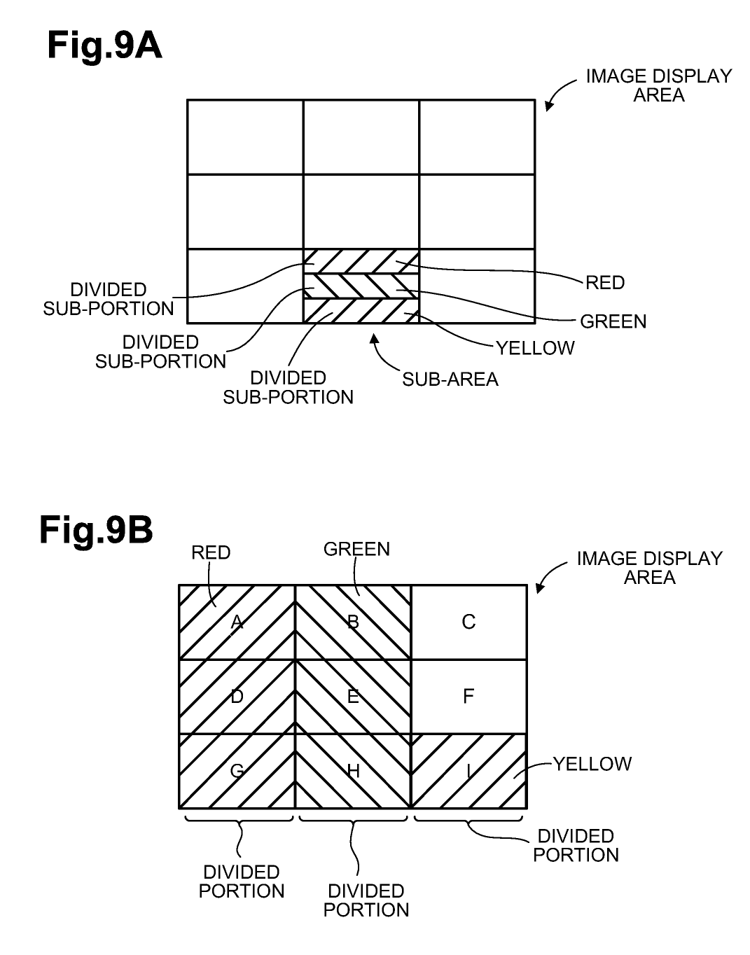

The characteristics shown in FIG. 6B were obtained when the test subjects observed an image with the right eye. When the test subjects observed an image with the right eye, the nine sub-areas are allocated so that they are symmetric to the nine sub-areas for the left eye with respect to the central line of the body of the test subject, as shown in FIG. 9A. The central line may be a vertical reference line passing through the nose of the test subject. Accordingly, when the eye of the user used to observe an image is switched between the left eye and the right eye, it may be necessary to change the display position of the information item.

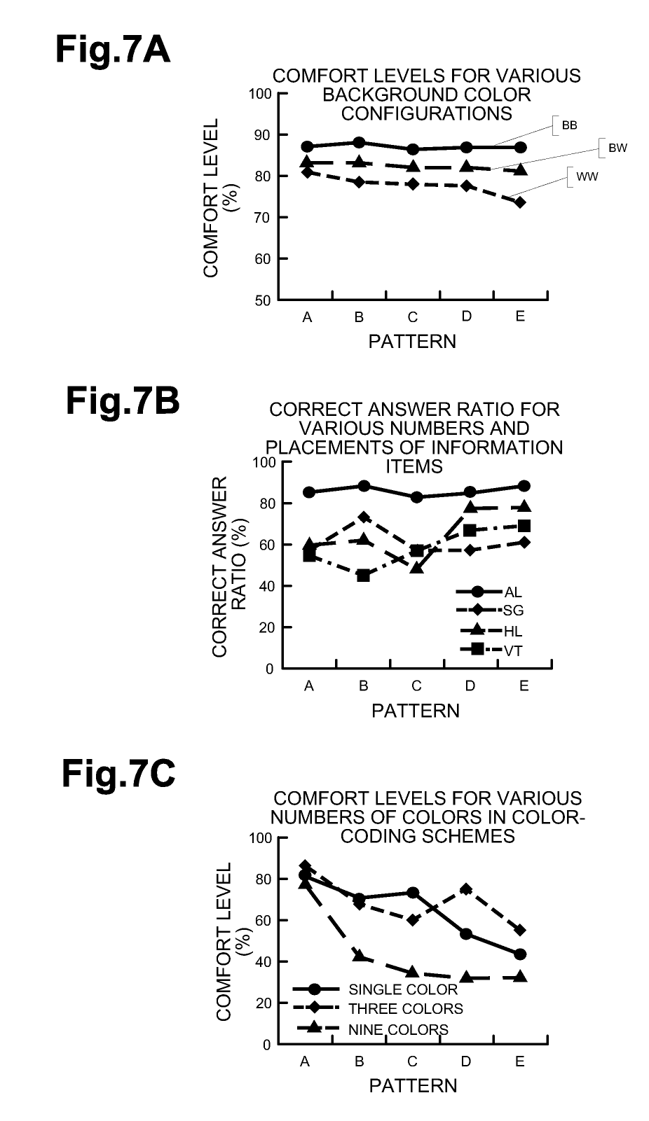

FIG. 7A shows the comfort levels of the test subjects based on various combinations of the patterns and background colors. As shown in FIG. 7A, when the background color was BB (e.g., complete black), the greatest comfort levels were obtained for each of the five patterns. Taking this result into consideration, the user experience may more likely be enhanced when the background color is BB. The result also indicated that enhancing a user experience may be correlated more strongly with background color than the type of pattern.

FIG. 7B shows a graph of the correct answer ratios of the test subjects (e.g., a ratio of the number of answers correctly identifying the information item to the total number of answers provided by the test subjects when asked to identify the information item displayed by the HMD 10) based on various combinations of the patterns, the quantity of information items, and the positions of the information items. As shown in FIG. 7B, when the quantity of information items and the positions of the information items were configured with the display condition AL, the correct answer ratios were highest among the five patterns, regardless of the type of pattern. When the HMD 10 was configured with the display condition HL or VL, the correct answer ratios associated with the patterns D and E tended to be greater when compared with the correct answer ratios associated with the other types of patterns. In the display conditions HL and VL, the nine information items were partially displayed, rather than displayed all at once. The patterns D and E represented an image that was relatively complex with a high color level. Taking this result into consideration, the correct answer ratio may be increased by using the display condition AL, in which information items are displayed all at once, without the display of information items being switched.

FIG. 7C shows a graph of the comfort levels of the test subjects based on various combinations of the pattern types and the quantity of colors in color-coding schemes. As shown in FIG. 7C, the comfort levels associated with the configuration in which each of the nine information items was displayed in a different color (e.g., nine colors were used in the color-coding scheme) were less than the comfort levels in the other display conditions, regardless of the type of pattern. For each of the patterns A, B, and C, the comfort levels associated with the configuration in which the nine information items were displayed in the same color were greater than the other display conditions. The quantity of colors in each of patterns A, B, and C was less than or equal to two. For each of the patterns D and E, the comfort levels associated with the configuration in which the nine information items were color-coded with three colors were greater than the other display conditions. The quantity of colors in each of the patterns D and E was greater than or equal to three, which represents a relatively complex image with a high color level. In general, the comfort levels associated with the configuration in which the nine information items were color-coded with three colors were higher than the other display conditions, regardless of the type of pattern. Taking this result into consideration, the user experience may more likely be enhanced when images are color-coded to be displayed with three colors. When the quantity of colors used to display an image to be displayed is to be reduced (e.g., when the pattern is one of A, B, and C and the color level is low), however, it may be desirable to display the image with a single color. When the pattern is one of D and E (e.g., the color level is high), it may be desirable to display the image using three colors. Thus, it may be desirable to change the quantity of colors to be used in an image to be displayed based on the pattern.

As inferred from FIG. 7C, when the total quantity of colors used concurrently to display an image is three, the comfort levels may be the greatest among the various color-coding experiments. When the quantity of colors used concurrently is less than three (e.g., 1) or is larger than three (e.g., 9), the comfort levels may be lower than the greatest comfort levels when the total quantity of colors used concurrently to display an image is three.

The HMD 10 may display at least one information item in some sub-areas selected from the nine sub-areas in the image display area based on information in a video signal entering the HMD 10 from the outside. The information item may comprise information that helps or supports a worker, who is a user, while working. The HMD 10 may determine the six attributes (e.g., design elements) used to display each information item based on the above-described experimental results, as described below.

In consideration of the experimental results, the font size used by the HMD 10 to display the information item may be 34 points or greater.

In consideration of the experimental results, a sub-area is selected from of the nine sub-areas described above as the position in which to display an information item based on the importance of the information item (e.g., whether the content of the information item is important to the user, how frequently the information item is referenced by the user).

To determine the display positions of the information items individually, sub-area selecting instructions that instruct the CPU 26 to perform a sub-area selecting process may be stored in the program ROM 27. The position of the sub-area (e.g., display sub-area) in which to display an information item may depend on one or more of the importance of the information item and whether the user observes the information item with the left eye or right eye (e.g., whether a left-eye observation mode or a right-eye observation mode is used).

In consideration of the experimental results, the background color of the information item may be set to BB (complete black).

In consideration of the experimental results, at least one color selected from the fourteen colors described above may used to display each information item.

In consideration of the experimental results, an information item may be displayed in only one sub-area of the image display area. The one sub-area in which the information item is displayed may be selected in the above-described manner. Nevertheless, a plurality of different information items may be simultaneously displayed in mutually different sub-areas in the image display area.

In consideration of the experimental results, the HMD 10 may be configured such that, when the color level of the external environment is less than or equal to a prescribed value, the quantity of colors in a color-coding scheme of at least one information item to be displayed may be determined to be one. The prescribed value may be two. When the pattern is one of A, B, and C, the quantity of colors detected in the external environment may be less than or equal to the prescribed value. In further consideration of the experimental results, the HMD 10 may be configured such that, when the color level of the external environment may be greater than the prescribed value, the quantity of colors in the color-coding scheme of at least one information item to be displayed may be determined to be three. When the pattern is D or E, the quantity of colors detected in the external environment may be greater than the prescribed value. Thus, the quantity of colors in the color-coding scheme of the information item may depend on the color level detected in the external environment. Even when four or more information items are displayed concurrently when the color level detected in the external environment is greater than the prescribed value, the total quantity of colors used to display the information items may be maintained at three.

To determine the quantity of colors in a color-coding scheme of the information item, as described above, quantity of colors determining instructions that instruct the CPU 26 to perform a quantity of colors determining process may be stored in the program ROM 27. The quantity of colors in the color-coding scheme of the information item may depend on the color level of the external environment, observed by the user, for example, together with the information item. Although in particular configurations the color level of the external environment may be automatically determined by using the image data imaged by the camera 23, in some configurations, the user may enter the color level of the external environment by, for example, operating the manipulation device 30. The sub-area selecting instructions and the quantity of colors determining instructions may be stored in the program ROM 27 before the HMD 10 is shipped from the factory. Alternatively, the sub-area selecting instructions and quantity of colors determining instructions may be received from an external device through the external input/output terminals 32 and may be subsequently be stored in the program ROM 27. The external device may be one or more of a drive that reads out programs stored on an optical medium, an external memory, and another storage medium. Alternatively or additionally, the external device may be a server connected through a network. When the external device is a server connected through a network, instructions stored on a storage medium in the server may be downloaded.

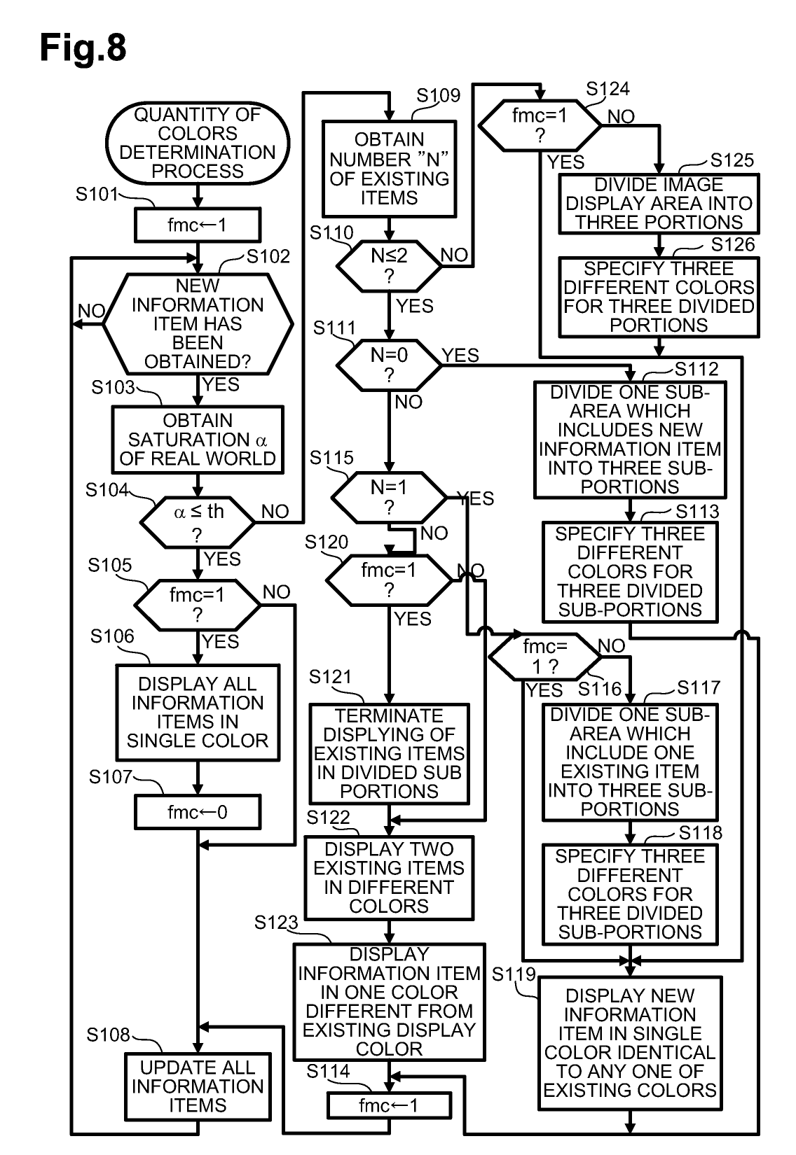

FIG. 8 is a flow chart showing the process steps performed by the CPU 26 in accordance with the quantity of colors determining instructions. The CPU 26 may read the quantity of colors determining instructions from the program ROM 27 and may execute the quantity of colors determining instructions, as appropriate.

When the HMD 10 is activated (e.g., turned on), the CPU 26 may execute the quantity of colors determining instructions. In step S101, the CPU 26 may set a flag fmc to 1. The flag fmc may indicate whether the HMD 10 is displaying an image in multi-color (e.g., displaying the image using a plurality of colors). When the flag fmc is set to 0, the flag fmc set to 0 may indicate that a single color display mode is in use. When the flag fmc is set to 1, the flag fmc set to 1 may indicate that a multi-color display mode is in use. In particular configurations, the HMD 10 may use the multi-color display mode by default, and, accordingly, the flag fmc may be set to 1 by default.

In step S102, the CPU 26 may determine whether a new information item (optionally referred to as a “new item” below) has been obtained based on a video signal received from an external apparatus that may be connected to the external input/output terminals 32. When the CPU 26 determines that a new item has not been obtained (S102:NO), the CPU 26 may repeat step S102 until the CPU 26 obtains a new item. When, for example, the CPU 26 obtains a new information item (e.g., an information item to be displayed by the HMD 10) via the external input/output terminals 32, the CPU 26 may make a positive determination in step S102 (S102:YES). In step S103, the CPU 26 may obtain a saturation value α for the external environment. The saturation value α may indicate the quantity of colors detected in the external environment.

In particular configurations, the CPU 26 may obtain the saturation value based on the image data imaged by the camera 23, without having to request user intervention. In particular configurations, the saturation value α may be used, rather than a hue, as the value that indicates the color level of the external environment. Nevertheless, a hue may be used instead of the saturation value α.

The saturation value α may be a physical quantity that may become 0 for achromatic colors (e.g., white, black, gray) and may be higher for pure colors. The saturation value α may be represented in a range from 0% to 100%.

For example, the saturation value α of a hue-saturation-value (“HSV”) color space may be determined from the red-green-blue (“RGB”) values in an RGB color space. The RGB values may comprise the brightness value R of the red light component, the brightness value G of the green light component, and the brightness value B of the blue light component. In this example, a greatest value and lowest value may be obtained from the image data imaged by the camera 23 for each of the R values, the G values, and the B values of the pixels in the imaging area of the camera 23. The saturation value α may be determined by dividing a difference between the obtained greatest value and lowest value by the greatest value.

The saturation value α may differ for each pixel. For example, the CPU 26 may divide the imaging area of the camera 23 into a plurality of blocks and may determine a saturation value α for each block. In some configurations, one or more of an average value, a mode value, and a median value of pixels in each block may be determined to be in the saturation value α corresponding to each block. In certain configurations, the CPU 26 may obtain one value, such as, for example, a greatest value, which may typify the plurality of blocks, as the saturation value α that may typify the imaging area of the camera 23.

Nevertheless, it may not be indispensable to use the camera 23 to determine the saturation value α. For example, a complementary metal oxide semiconductor (“CMOS”) sensor or another light receiving element may be used instead.

In step S104, the CPU 26 may determine whether the obtained saturation value α is less than or equal to a threshold. In particular configurations, the threshold may have been set to 20%. When the saturation value α is less than or equal to 20%, for example, the CPU 26 may determine that the pattern may correspond to one or more of A, B, and C (e.g., the quantity of colors in the external environment is less than or equal to two). When the saturation value α is greater than 20%, the CPU 26 may determine that the pattern may correspond to one or more of D and E (e.g., the quantity of colors in the external environment is less than or equal to four). Consequently, in step S104, the CPU 26 may determine whether the pattern is one or more of A, B, and C. When the CPU 26 determines that the saturation value α is less than or equal to the threshold from the experimental result described above (S104:YES), based on the experimental results, the HMD 10 may increase the comfort level of the user by displaying the information items, which may also comprise the new item, in a single color.

Consequently, when the saturation value α is less than or equal to the threshold, the CPU 26 may make a positive determination in step S104 (S104:YES), and the CPU 26 may proceed to step S105 and may determine whether the flag fmc is equal to 1. In S105, when the flag fmc is 1, the CPU 26 may make a positive determination in step S105 (S105:YES), and the process may proceed to step S106. When the current execution of the quantity of colors determination instructions by the CPU 26 is the initial execution after the power to the HMD 10 has been turned on, the flag fmc may be equal to 1.

In step S106, the CPU 26 may display the information items in a single color. When there is no existing information item (referred to below as an “existing item”), the information items may, for example, all be new information items (referred to below as a “new item”). When there are existing items, the information items may be a combination of existing items and new items. A display color common to all information items may be selected in advance. The display color that is selected in advance may be, for example, a color that may receive a high value of subjective evaluation by the user, such as one of red, green, and yellow, for example.

In step S107, the CPU 26 may set the flag fmc to 0. Thus, the display mode of the HMD 10 may be switched from the multi-color display mode to the single color display mode. In step S108, the CPU 26 may update the information items. For example, the CPU 26 may update the data of all information items, which may have been stored in the flash ROM 28.

When the flag fmc is equal to 0, the CPU 26 may make a negative determination in step S105 (S105:NO), and the CPU 26 may omit steps S106 and S107. Thus, the single color display mode, in which the information items are displayed in a single color, may be continued. Consequently, the process may proceed to step S108.

When the saturation value α is greater than the threshold, the CPU 26 may make a negative determination in step S104 (S104:NO). Based on the experimental results, because the pattern may therefore be one or more of D and E, the HMD 10 may increase a comfort level of the user by displaying the information items in three colors. Consequently, the process may proceed to step S109, and the CPU 26 may obtain the quantity N of existing items. Because data associated with the existing items has been stored in the flash ROM 28, the CPU 26 may refer the contents of the flash ROM 28 and may execute step S109.

In step S110, the CPU 26 may determine whether the quantity N of existing items is less than or equal to two. When the quantity N of existing items is less than or equal to two, the CPU 26 may make a positive determination in step S110 (S110:YES), the process may proceed to step S111, and the CPU 26 may determine whether the quantity N of existing items is equal to zero. When the quantity N of existing items is zero (e.g., there may no existing items), and the CPU 26 may make a positive determination in step S111 (S111:YES), and the process may proceed to step S112.

In step S112, the CPU 26 may divide one sub-area, which may comprise the new item, into three sub-portions to display the new item in three colors. For example, as shown in FIG. 9A, the sub-area (e.g., sub-area H) may be vertically divided into three sub-portions, each of which may extend horizontally.

In step S113, the CPU 26 may specify three mutually different colors for the three divided sub-portions. For example, as shown in FIG. 9A, the CPU 26 may specify red, green, and yellow as the colors for the three divided sub-portions. Thus, the CPU 26 may display the new item in three colors, and the HMD 10 may function as a type of multi-color display, and the process may proceed to step S114.

In step S114, the CPU 26 may set the flag fmc to 1. Subsequently, the process may proceed to step S108.

When the CPU 26 determines that the quantity N of existing items is not zero in step S111, the CPU 26 may make a negative determination in step S111 (S111:NO), the process may proceed to step S115, and the CPU 26 may determine whether the quantity N of existing items is equal to one. When one existing item is present, the CPU 26 may make a positive determination in step S115 (S115:YES), and the process may proceed to step S116.

In step S116, the CPU 26 may determine whether the flag fmc is equal to 1. When only one existing item is present, the flag fmc may be equal to 1, and the CPU 26 may determine that the one existing item has been displayed in divided areas as a result of step S113. Consequently, when the CPU 26 determines that the flag fmc is equal to 1 in step S116, the CPU 26 may make a positive determination in step S116 (S116:YES), and the process may proceed to step S119. In step S119, the CPU 26 may display the new item in a single color that is identical to one of the existing display colors (e.g., the three colors described above). Accordingly, the total quantity of colors used to display the information items may not exceed three. Subsequently, the process may proceed to step S114.

When the flag fmc is equal to 0, then the CPU 26 may determine that the one existing item was displayed in a single color, and the CPU 26 may make a negative determination in step S116 (S116:NO), and the process may proceed to step S117. In step S117, the CPU 26 may divide one sub-area in which the one existing item is being displayed into three sub-portions in a manner similar to the processing in step S112. Subsequently, the process may proceed to step S118.

In step S118, the CPU 26 may specify different colors for the three divided sub-portions, generated by the division by three in step S117. Step S118 may be substantially similar to step S113. Thus, the CPU 26 may display one existing item in three colors. Upon completion of step S118, the process may proceed to step S119. Accordingly, the total quantity of colors used to display the information items may not exceed three. Subsequent to step S119, the process may proceed to step S114.

When the quantity N of existing items is not equal to one (e.g., the quantity N of existing items is equal to two), the CPU 26 may make a negative determination in step S115 (S115:NO), the process may proceed to S120, and the CPU 26 may determine whether the flag fmc is equal to 1.

When the flag fmc is equal to 1 and only two existing items are present (e.g., present in the flash ROM 28), the CPU 26 may determine that one of the two existing items has been displayed in sub-portions divided as described above. Because the total quantity of information items (e.g., the two existing items and the new item) is three, even when each of the information items are displayed in a single color by using mutually different colors, the total quantity of colors used to display the information items is three. Accordingly, some of the existing items may not need to be displayed in divided sub-portions.

When the CPU 26 determines that the flag fmc is equal to 1 in step S120, the CPU 26 may make a positive determination in step S120 (S120:YES), the process may proceed to step S121, and the CPU 26 may terminate the displaying of the existing items in divided sub-portions. Subsequently, the process may proceed to step S122. In step S122, the CPU 26 may display two existing items in different colors (e.g., red and green). Subsequently, the process may proceed to step S123.

In step S123, the CPU 26 may display the new item using a color (e.g., yellow) that is different from the two colors (e.g., the existing display colors) used to display the two existing items. Subsequently, the process may proceed to step S114.

When the CPU 26 determines that the flag fmc is equal to 0 in step S120, the CPU 26 may determine that the two existing items have been displayed in the same color. Consequently, the CPU 26 may make a negative determination in step S120 (S120:NO), and the process may omit step S121 and proceed to step S122.

When the CPU 26 determines that the quantity N of existing items is three in step S110, the CPU 26 may make a negative determination in step S110 (S110:NO), the process may proceed to step S124, and the CPU 26 may determine whether the flag fmc is equal to 1.

When the CPU 26 determines that three existing items are present and the flag fmc is equal to 1 in S124, the CPU 26 may determine that each of the three existing items has been displayed in a single color by using mutually different colors (e.g., a total of three colors). Consequently, the CPU 26 may make a positive determination in step S124 (S124:YES), and the process may proceed to step S119, in which the CPU 26 may display the new item using a color identical to one (e.g., red) of the existing display colors (e.g., the three colors described above). Accordingly, the total quantity of colors used to display the four information items (e.g., the three existing items and the new item) may not exceed three. Subsequently, the process may proceed to step S114.

When the CPU 26 determines that the flag fmc is equal to 0 in step S124 (S124:NO), the CPU 26 may determine that the three existing items have been displayed in the same color. Subsequently, the process may proceed to step S125, and the CPU 26 may divide the image display area into three portions to display the three existing items using mutually different colors (e.g., a total of three mutually different colors). For example, the image display area may be divided horizontally into three portions. Each of the three divided portions may extend vertically, as shown in FIG. 9B. The direction in which the image display area is divided may be determined to comprise at least one information item in each of the three divided portions. For example, the image display area may be divided vertically into three portions. Subsequently, the process may proceed to S126.

In step S126, the CPU 26 may specify three mutually different colors for the three divided portions. For example, the CPU 26 may specify red, green, and yellow for the three divided portions, as shown in FIG. 9B. Thus, the three information items may be displayed in the multi-color display mode, in which each information item is displayed in a single color and a total of three colors are used to display the three information items. Subsequently, the process may proceed to step S119.

When the CPU 26 determines that the quantity N of existing items is four in step S110, the CPU 26 may make a negative determination in step S110 (S110:NO), the process may proceed to step S124, and the CPU 26 may determine whether the flag fmc is equal to 1. When the CPU 26 determines that four existing items are present and the flag fmc is equal to 1 in step S124, the CPU 26 may determine that the four existing items have been displayed using a total of three colors. In particular, the CPU 26 may determine that each of the four existing items have been displayed in a single color, respectively. Consequently, the CPU 26 may make a positive determination in step S124, and the process may proceed to step S119, in which the CPU 26 may display the new item using a color identical to one color (e.g., red) of the existing display colors (e.g., the three colors described above). Accordingly, the total quantity of colors used to display the five information items (e.g., the four existing items and the new item) may not exceed three. Subsequently, the process may proceed to step S114.

When the CPU 26 determines that the flag fmc is equal to 0, rather than 1, in step S124, the CPU 26 may determine that the four existing items have been displayed in the same color. Consequently, the process may proceed to step S125, and the CPU 26 may divide the image display area into three portions to display the four existing items using three colors. Subsequently, the process may proceed to step S126. In step S126, the CPU 26 may specify three mutually different colors for the three divided portions. Thus, the four information items may be displayed in the multi-color display mode in which each information item may be displayed in a single color, and a total of three colors may be used to display the four information items. Subsequently, the process may proceed to step S119.

When the CPU 26 determines that the quantity N of existing items is five or more in step S110, the CPU 26 may execute the quantity of colors determining instructions in a manner similar to that when the CPU 26 determines that the quantity N of existing items is four. Accordingly, repeated descriptions of the processes performed by the CPU 26 are omitted.

Thus, in particular configurations, an upper limit of 2or greater may be preset for the quantity of colors, which may be a total quantity of colors used to display the information items. Specifically, the upper limit in some configurations may be 3. Thus, in particular configurations, for example, even when the quantity of information items that are concurrently present in an image to be displayed exceeds a value equal to the upper limit, the quantity of colors may be maintained at the upper limit.

Furthermore, when a new item is entered, the quantity of colors determining instructions, as shown in FIG. 8, may switch the display condition of the information item between a single color display and a three-color display, based on the saturation α of the external environment at that time. Therefore, even when the saturation α changes during a period between a time at which an information item is entered and a time at which a subsequent information item is entered, the display condition of the information item may not be changed to reflect the change of the saturation α. This may occur because the quantity of colors determining instructions may be designed so that, even when the saturation α changes, the quantity of colors in color coding may remain unchanged.

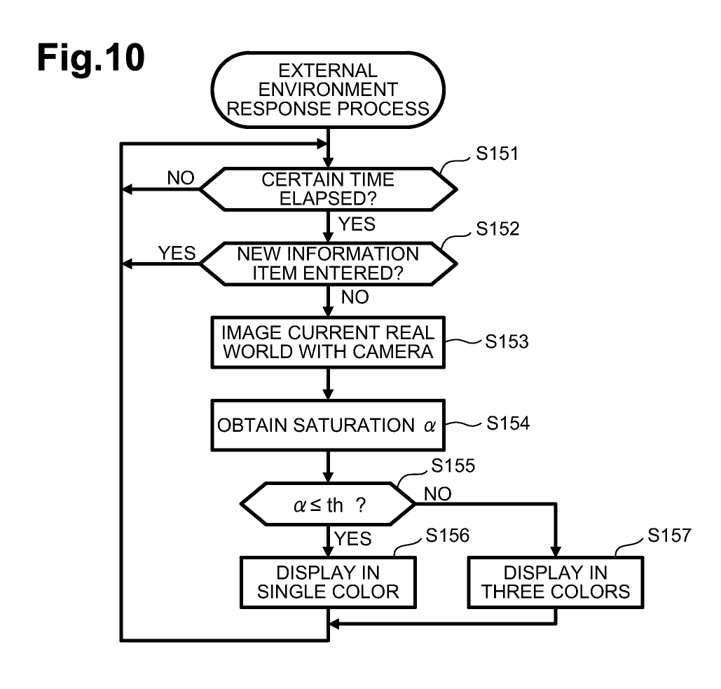

FIG. 10 conceptually represents an external environment response process, which may be performed by the CPU 26 executing external environment response instructions, in the form of a flowchart, which may change the display condition (e.g., the quantity of colors in the color coding scheme) in response to a change in the saturation α in the external environment. In certain configurations, the external environment response process may be performed in parallel with the quantity of colors determining process. In some configurations, the external environment response process may be a main process performed by the CPU 26, and the quantity of colors determining process may be initiated in response to a new item being entered.

In the external environment response process, the CPU 26 may perform step S151 and wait until a certain time (e.g., 10 seconds) has elapsed. Specifically, when the CPU 26 determines that the certain time has not elapsed (S151:NO), the CPU 26 may repeat step S151. The length of the certain time may correspond to the length of an interval at which the camera 23 may intermittently image the external environment and obtain the saturation α from the image data. Subsequent to the certain time elapsing, the CPU 26 may make a positive determination in step S151 (S151:YES), and the process may proceed to step S152.

In step S152, the CPU 26 may determine whether a new item has been entered. When the CPU 26 makes a positive determination in step S152 (S152:YES), the CPU 26 may initiate the quantity of colors determining process and determine the quantity of colors in the color coding scheme using the saturation α of the external environment. When the CPU 26 is performing the quantity of colors determining process and determining the quantity of colors in the color coding scheme, the CPU 26 may omit steps S153 through S157 of the external environment response program, and the external environment response process may return to step S151. Thus, when the CPU 26 makes a positive determination in step S152 (S152:YES), the process may return to step S151.

When the CPU 26 makes a negative determination in step S152 (S152:NO), the process may proceed to step S153. In step S153, the CPU 26 may image the current external environment with the camera 23. Subsequently, the process may proceed to step S154, and the CPU 26 may obtain the saturation α from the image data imaged by the camera 53. Subsequently, the process may proceed to step S155.

In step S155, the CPU 26 may determine whether the saturation α obtained in step S154 is less than or equal to a threshold th (e.g., 20%). When the CPU 26 determines that the saturation α is less than or equal to threshold th (S155:YES), the process may proceed to step S156, and the CPU 26 may display the information items in a single color. Subsequently, the process may return to step S151. When the CPU 26 determines that the saturation α is greater than the threshold th, the process may proceed to step S157, and the CPU 26 may display the information items in three colors in a manner similar to process performed in the quantity of colors determining process described above. Subsequently, the process may return to step S151.

Consequently, when the CPU 26 makes a negative determination in step S152 (S152:NO), the CPU 26 subsequently may perform steps S153 through S155 and one of steps S156 and S157. As described above, the combination of steps S153 through S155 and one of steps S156 and S157 may correspond to another quantity of colors determining process that is performed by the CPU 26 as part of the external environment response process shown in FIG. 10, rather than as part of the quantity of colors determining process shown in FIG. 8. Thus, the CPU 26 may periodically update the number of colors displayed by the projection device 12 even when new information items have not been entered.

Particular configurations of the present disclosure have been described in detail with reference to the drawings. Nevertheless, particular configurations disclosed herein are merely exemplary configurations. The present disclosure may be configured in many other forms in which various variations and improvements may be made on the basis of the knowledge of those skilled in the art.

While the invention has been described in connection with various exemplary structures and illustrative configurations, it will be understood by those skilled in the art that other variations and modifications of the structures, configurations, and embodiments disclosed above may be made without departing from the scope of the invention. For example, this application comprises each and every possible combination of the various elements and features disclosed and incorporated by reference herein, and the particular elements and features presented in the claims and disclosed and incorporated by reference above may be combined with each other in each and every possible way within the scope of the application, such that the application should be recognized as also directed to other embodiments comprising other possible combinations. Other structures, configurations, and embodiments consistent with the scope of the claimed invention will be apparent to those skilled in the art from a consideration of the specification or practice of the invention disclosed herein. It is intended that the specification and the described examples are illustrative with the true scope of the invention being defined by the following claims.

What is claimed is:

1. A wearable display control device comprising:
one or more processors; and
a memory storing computer-readable instructions therein, the computer-readable instructions, when executed by the one or more processors, instructing the one or more processors to perform processes comprising:
obtaining a color level of an environment external to the wearable display;
determining a quantity of display colors based on the color level; and
controlling a display device to display an image using a number of display colors equal to the quantity of display colors determined based on the color level, the image comprising one or more display objects, and each display object of the one or more display objects being displayed in at least one of the display colors.

2. The wearable display control device according to claim 1, wherein determining the quantity of display colors comprises:
determining the quantity of display colors to be one when the color level is less than or equal to a threshold level.

3. The wearable display control device according to claim 2, wherein determining the quantity of display colors comprises:
determining the quantity of display colors to be a predetermined number when the color level is greater than the threshold, the predetermined number being greater than or equal to two.

4. The wearable display control device according to claim 1,
wherein the computer-readable instructions, when executed by the one or more processors, instruct the one or more processors to perform processes further comprising:
obtaining the one or more display objects from an external apparatus, which is external to the wearable display, and
wherein obtaining the color level of the environment external to the wearable display comprises:
obtaining the color level of the environment external to the wearable display in response to obtaining the one or more display objects from the external apparatus.

5. The wearable display control device according to claim 1,
wherein the one or more display objects comprises a plurality of display objects, and
wherein controlling the display device to display the image comprises controlling the display device to display each display object of the plurality of display objects in one color of the display colors, such that each of the display colors is displayed at least once.

6. The wearable display control device according to claim 5, wherein controlling the display device to display the image further comprises:
dividing the image into a plurality of sub-areas when a quantity of display objects in the plurality of display objects is greater than the quantity of display colors, the plurality of sub-areas comprising a quantity of sub-areas equal to the quantity of display colors; and
designating particular display colors from the display colors for each sub-area of the plurality of sub-areas, the particular display colors being different from each other.

7. The wearable display control device according to claim 1, wherein controlling the display device to display the image comprises:
displaying at least one of the one or more display objects in a plurality of colors when a quantity of display objects in the one or more display objects is less than a predetermined number, the predetermined number being greater than or equal to two.

8. The wearable display control device according to claim 1,
wherein the computer-readable instructions, when executed by the one or more processors, instruct the one or more processors to perform processes further comprising:
controlling a camera to record an image of the environment external to the wearable display, and
wherein obtaining the color level comprises:
obtaining the color level based on the image of the environment external to the wearable display.

9. The wearable display control device according to claim 8, wherein the color level corresponds to a saturation value of the image of the environment external to the wearable display.

10. The wearable display control device according to claim 1,
wherein the computer-readable instructions, when executed by the one or more processors, instruct the one or more processors to perform processes further comprising:
dividing the image into a plurality of reference areas, and wherein controlling the display device to display the image comprises:
displaying at least one of the one or more display objects in a lowest central reference area of the plurality of reference areas of the image.

11. A non-transitory computer-readable medium storing computer readable instructions therein that, when executed by one or more processors of a wearable display, instruct the one or more processors to perform processes comprising:
obtaining a color level of an environment external to the wearable display;
determining a quantity of display colors based on the color level; and
controlling a display device to display an image using a number of display colors equal to the quantity of display colors determined based on the color level, the image comprising one or more display objects, and each display object of the one or more display objects being displayed in at least one of the display colors.

12. A wearable display comprising:
a camera configured to record an image of an environment external to the wearable display;
a color level obtaining device configured to obtain a color level from the image of the environment external to the wearable display;
a color determining device configured to determine a quantity of display colors based on the color level; and
a display device configured to display an image using a number of display colors equal to the quantity of display colors determined based on the color level, the image comprising one or more display objects,
wherein each display object of the one or more display objects is displayed in at least one of the display colors.
